(19) United States
(12) Patent Application Publication
(10) Pub. No.: US 2024/0049756 A1
(43) Pub. Date: Feb. 15, 2024

(54) ONION PROCESSED PRODUCT AND METHOD FOR PRODUCING SAME

(71) Applicant: HOUSE FOODS GROUP INC., Higashiosaka-shi, Osaka (JP)

(72) Inventors: Koshi Hanyuda, Higashiosaka-shi, Osaka (JP); Masahiro Kato, Higashiosaka-shi, Osaka (JP); Shingo Komada, Higashiosaka-shi, Osaka (JP)

(73) Assignee: HOUSE FOODS GROUP INC., Higashiosaka-shi, Osaka (JP)

(21) Appl. No.: 18/266,773

(22) PCT Filed: Dec. 14, 2021
(86) PCT No.: PCT/JP2021/046076

§ 371 Date: Jun. 12, 2023

(30) Foreign Application Priority Data
Dec. 14, 2020 (JP) 2020-206862
Dec. 14, 2020 (JP) 2020206862

(51) Int. Cl. A23L 19/00

(52) U.S. Cl. CPC A23L 19/00

(57) ABSTRACT

The present invention provides an onion processed product which is less pungent and less bitter and has natural sweet flavor of onions and freshness, and a method for producing the same. The onion processed product disclosed in the present description has a pyruvic acid content of less than 3.8 μmol/g and a hexanal content of 0.025 ppm (wt/wt) or more with respect to the amount of the onion processed product calculated in terms of raw onion as a raw material. The method for producing an onion processed product as disclosed in the present description comprises the steps of: cutting an onion; heating the cut onion at 50° C. or more so that the cooking value obtained by integrating a value for an onion product temperature (A) [° C.], which is calculated by 10^{{(A-40)/10}}, with the time of heating [minute] is 900 or more and less than 10,000; and processing the heated onion to produce an onion processed product.

### TECHNICAL FIELD

The present invention relates to an onion processed product and a method for producing the same.

### BACKGROUND ART

Onions are one of flavoring vegetables. A processed product obtained by cutting a raw onion directly or forming it into paste has excessive bitterness and pungency.

Patent Literature 1 discloses a method for producing an onion processed product for acidic seasoning which has a fresh feeling, moderate bitterness and pungency, and sufficient umami, and is not discolored when added to acidic seasoning, the method comprising step A: a step of heating a hall-shaped onion to a center temperature of 60° C. to 80° C. using steam; and step B: a step of finely cutting the onion obtained in step A, or forming it into paste.

Patent Literature 2 discloses a method for bringing out sweet flavor from a vegetable of the lily family, comprising heating a vegetable of the lily family such as an onion in a water bath at 80° C. or more, and maintaining the vegetable at a temperature of 60 to 80° C. for 0 to 20 minutes after the center part thereof reaches such a temperature. Patent Literature 2 indicates that this method enables suppression of an irritant odor and an irritant taste inherent in onions while maintaining the natural sweet flavor of onions. Patent Literature 2 describes Example of the method in which the entire form of an onion is heated in water at a predetermined temperature.

### CITATION LIST

### Patent Literature

Patent Literature 1: JP Patent Publication (Kokai) No. 2015-047138

Patent Literature 2: JP Patent Publication (Kokai) No. 2007-319139

### SUMMARY OF INVENTION

### Technical Problem

The present invention provides an onion processed product which is less pungent and less bitter and has natural sweet flavor of onions and freshness, and a method for producing the same.

### Solution to Problem

In the present description, the following inventions are disclosed as inventions relating to an onion processed product which is less pungent and less bitter and has natural sweet flavor of onions and freshness, and a method for producing the same.

(1) An onion processed product having a pyruvic acid content of less than 3.8 μmol/g and a hexanal content of 0.025 ppm (wt/wt) or more with respect to the amount of the onion processed product calculated in terms of raw onion as a raw material.

(2) The onion processed product according to (1), wherein the pyruvic acid content is less than 1.5 μmol/g with respect to the amount calculated in terms of raw onion as a raw material.

(3) The onion processed product according to (1) or (2), which is a processed product of an onion in which expression of the alliinase gene is suppressed to less than 1/50 as compared to conventional breeds.

(4) A method for producing an onion processed product, comprising:
a step of cutting an onion;
a step of heating the cut onion at 50° C. or more so that the cooking value is 900 or more and less than 10,000; and
a step of processing the heated onion to produce an onion processed product, wherein
the cooking value is obtained by integrating a value for an onion product temperature (A) [° C.], which is calculated by 10^{{(A-40)/10}}, with the time of heating [minute].

(5) The method according to (4), wherein the onion is an onion in which expression of the alliinase gene is suppressed to less than 1/50 as compared to conventional breeds.

The description encompasses the disclosure of JP Patent Application No. 2020-206862, on which the priority of the present application is based.

### Advantageous Effect of Invention

The onion processed product disclosed in the present description is less pungent and less bitter, and has natural sweet flavor of onions and freshness.

According to the method for producing an onion processed product as disclosed in the present description, it is possible to produce an onion processed product having the characteristics described above.

### DESCRIPTION OF EMBODIMENTS

In the following, the present invention will be described in more detail.

### <Onion Processed Product>

An embodiment of an onion processed product as disclosed in the present description has a pyruvic acid content of less than 3.8 μmol/g and a hexanal content of 0.025 ppm (wt/wt) or more with respect to the amount of the onion processed product calculated in terms of raw onion as a raw material.

The onion processed product of the present embodiment is less pungent and less bitter and has natural sweet flavor of onions and freshness, and can be directly used for drinking and eating as a material for juice or dessert, and also used as seasoning.

As the onion processed product, puree, paste, juice (squeezed juice, concentrated squeezed juice or diluted squeezed juice), crushed products and the like of onions (in the present description, scaly bulbs of onions unless otherwise specified) can be exemplified.

The onion processed product can be in the form of a packaged onion processed product put in a bag-like container, a bottle, a can, a PET container, or the like.

In the present description, the term “pyruvic acid content and the hexanal content with respect to the “amount of the onion-processed product calculated in terms of raw onion as a raw material”” refers to the contents of pyruvic acid and hexanal in a predetermined amount of the onion processed product with respect to the amount of a raw onion as a raw material, which are used for producing the predetermined amount of the onion processed product.

When cells are destroyed due to processing of onions, trans-1-propenylcystein sulfoxide (PRENCSO) is degraded by alliinase, so that sulfenic acid, pyruvic acid and ammonia are produced from PRENCSO. By the action of a lacrimatory factor synthetase (LFS), the sulfenic acid is further changed into a lacrimatory factor that is also a bitterness component. The pyruvic acid in the onion processed product is derived from this reaction, and pungency and bitterness increase as the pyruvic acid content becomes higher.

Meanwhile, hexanal is a flavor component related to a grassy odor and freshness.

The onion processed product of the present embodiment has sufficiently low pungency and bitterness as the pyruvic acid content is less than 3.8 μmol/g with respect to the amount of the onion processed product calculated in terms of raw onion as a raw material, and the onion processed product has natural sweet flavor of onions and freshness as the hexanal content is 0.025 ppm (wt/wt) or more with respect to the amount of the onion processed product calculated in terms of raw onion as a raw material.

More preferably, the onion processed product of the present embodiment has a pyruvic acid content of less than 1.5 μmol/g and a hexanal content of 0.025 ppm (wt/wt) or more with respect to the amount of the onion processed product calculated in terms of raw onion as a raw material. In this case, pungency and bitterness are further low, and a fresh feeling from hexanal is particularly noticeable.

The pyruvic acid content in the onion processed product of the present embodiment is further preferably 1.4 μmol/g or less. The lower limit of the pyruvic acid content in the onion processed product of the present embodiment is not particularly limited, and the pyruvic acid content may be preferably 0.5 μmol/g or more, more preferably 0.9 μmol/g or more, with respect to the amount of the onion processed product calculated in terms of raw onion as a raw material.

The hexanal content in the onion processed product of the present embodiment is further preferably 0.070 ppm (wt/wt) or more. The upper limit of the hexanal content in the onion processed product of the present embodiment is not particularly limited, and the hexanal content may be preferably 0.30 ppm (wt/wt) or less, more preferably 0.20 ppm (wt/wt) or less, with respect to the amount of the onion processed product calculated in terms of raw onion as a raw material.

The onion that is used as a raw material is not particularly limited, and is preferably an onion in which expression of the alliinase gene is suppressed to less than 1/50 as compared to conventional breeds. The alliinase is an enzyme that catalyzes a reaction in which sulfenic acid, pyruvic acid and ammonia are produced from PRENCSO as described above. When an onion processed product is produced using an onion in which expression of the alliinase gene is suppressed to less than 1/50 as compared to conventional breeds, production of pyruvic acid by alliinase can be suppressed by milder heating as compared to a case where a conventional breed is used, and therefore it is possible to obtain an onion processed product having a low pyruvic acid content while avoiding reduction of the hexanal content which is caused by the heating.

A preferred example of the onion in which expression of the alliinase gene is suppressed to less than 1/50 as compared to conventional breeds will be described.

In the onion in which expression of the alliinase gene is suppressed to less than 1/50 as compared to conventional breeds, production of the pungency component and the lacrimatory component at the time of crushing cells is reduced as compared to conventional breeds.

Here, the term “alliinase gene” is a generic term of a plurality of alliinase genes comprising one or more single-nucleotide polymorphisms (SNP) unless otherwise specified.

Preferably, the “alliinase gene” is a specific alliinase gene which mainly contributes to production of the pungency component and the lacrimatory component.

The specific alliinase gene comprises or consists of a nucleotide sequence encoding the following polypeptide (a), (b) or (c):
(a) polypeptide comprising or consisting of an amino acid sequence set forth as SEQ ID NO: 1;
(b) polypeptide comprising or consisting of an amino acid sequence set forth as SEQ ID NO: 1 in which one or more amino acids are deleted, substituted, inserted and/or added, and having alliinase activity; or
(c) polypeptide comprising or consisting of an amino acid sequence having an identity of 70% or more, 80% or more, 90% or more, 95% or more, 96% or more, 97% or more, 98% or more or 99% or more to an amino acid sequence set forth as SEQ ID NO: 1, and having alliinase activity.

More preferably, the alliinase gene comprises a nucleotide sequence encoding the following polypeptide (a) or (b):
(a) polypeptide comprising an amino acid sequence set forth as SEQ ID NO: 1; or
(b) polypeptide comprising an amino acid sequence having an identity of 95% or more, 96% or more, 97% or more, 98% or more or 99% or more to an amino acid sequence set forth as SEQ ID NO: 1, and having alliinase activity.

Particularly preferably, the alliinase gene comprises a nucleotide sequence encoding the polypeptide of (a).

Here, the term “two or more” means ten, nine, eight, seven, six, five, four, three or two. Comparison of amino acid sequences can be performed by a known method, for example, by using Basic Local Alignment Search Tool at the National Center for Biological Information (BLAST) by default. Further, the term “alliinase activity” means activity for degrading PRENCSO to produce sulfenic acid, pyruvic acid and ammonia. The alliinase activity can be determined by detecting and measuring a substance produced by degradation of PRENCSO or a substance further produced from the foregoing substance (sulfenic acid is converted into LF by the action of LFS), by HPLC.

The result of conducting a search with Protein Blast of NCBI (a default is used for a parameter) using an amino acid sequence set forth as SEQ ID NO: 1 as a query sequence shows that SEQ ID NO: 1 has a high homology of 99.8% (478a.a./479a.a.), 99.8% (478a.a./479a.a.) and 98.7% (473a.a./479a.a.) with Accession Nos of AAA32639.1, AAA92463.1 and AAD26853.1, respectively.

The phrase “expression of the alliinase gene is suppressed to less than 1/50 as compared to conventional breeds” means that the expression level of the alliinase gene in onion cells may be less than 1/50 and is preferably less than 1/100, less than 1/200, less than 1/300, less than 1/400, less than 1/500, less than 1/600, less than 1/700, less than 1/800, less than 1/900, less than 1/1000, less than 1/2000, less than 1/3000, less than 1/4000, less than 1/5000, less than 1/6000, less than 1/7000, less than 1/8000, less than 1/9000, less than 1/10000, or less, as compared to expression level of alliinase gene in onion cells of conventional breeds. The expression of the gene is not required to be deleted, or may be deleted. The expression level of the alliinase gene in the onion can be evaluated based on the amount of mRNA in the alliinase gene.

In the present description, the term “conventional breed” refers to a common onion in which pungency and lacrimatory sensation are felt upon crushing of onion cells, and examples thereof include existing common spring sowing cultivated onions (for example, Super-Kitamomiji, Kitamomiji 2000, Kitamomiji, Sapporoki, Pole Star, Tsukihikari, Kitamiki, Gekko No. 22 and Okhotsk), and autumn sowing cultivated onions (for example, Osakamaru, Sennankodaka, Senshutyukoki, Satsuki and Momiji), with Super-Kitamomiji, Kitamomiji 2000, Sapporoki and the like being preferable.

In the “onion in which expression of the alliinase gene is suppressed to less than 1/50 as compared to conventional breeds”, PRENCSO contained in onion cells remains without being degraded and converted by the action of alliinase at the time of crushing onion cells because expression of the alliinase gene is suppressed as compared to conventional breeds.

In the “onion in which expression of the alliinase gene is suppressed to less than 1/50 as compared to conventional breeds”, the amount of remaining PRENCSO in the pulverized product of scaly bulbs of onions is preferably 2.0 μmol/g FW or more, further preferably 3.0 μmol/g FW or more, more preferably 4.0 μmol/g FW or more, particularly preferably 5.0 μmol/g FW or more, and/or the amount of pyruvic acid produced is preferably 2.0 μmol/g FW or less, further preferably 1.5 μmol/g FW or less, more preferably 1.0 μmol/g FW or less, particularly preferably 0.5 μmol/g FW or less, and/or in the “onion in which expression of the alliinase gene is suppressed to less than 1/50 as compared to conventional breeds”, the amount of LF produced about 1 minute and 20 seconds after onion cells are crushed is preferably 1.0×10⁶ peak area/μL of extract or less, more preferably 9.0×10⁵ peak area/μL of extract or less, 8.0×10⁵ peak area/μL of extract or less, 7.0×10⁵ peak area/μL of extract or less or 6.0×10⁵ peak area/μL of extract or less, further preferably 5.0×10⁵ peak area/μL of extract or less, 4.0×10⁵ peak area/lit of extract or less, 3.0×10⁵ peak area/μL of extract or less, 2.0×10⁵ peak area/μL of extract or less or 1.0×10⁵ peak area/μL of extract or less.

The amount of remaining PRENCSO is the amount of PRENCSO in the crushed liquid sample 3 hours after the raw onion is crushed. The higher the amount of remaining PRENCSO, the higher the alliinase activity. The amount of remaining PRENCSO can be measured using HPLC. The measurement of the amount of remaining PRENCSO can be performed a method described in International Publication WO 2014/178420, and the outline thereof is as follows.

The following specific portion is used as a sample for analysis of the amount of remaining PRENCSO. A raw onion bulb is divided into two parts along a plane perpendicular to a vertical axis of the bulb (axis extending through a base portion and a tip portion of the onion bulb) at a height lower by ⅓ to ½ than the upper end of the bulb, and a sample for analysis is collected from a scaly leaf at the center part of the obtained cut surface in the upper side portion (including the tip portion) or the lower side portion (including the base portion). 600 mg of onion tissues collected in this way are put in Safe-Lock Tube (2 mL) manufactured by Eppendorf Company, which contain three 3 mmϕ zirconia balls. 0.6 mL of distilled water is added, and the mixture is crushed by treatment of 30 Hz×2 min×3 times using MM 300 Model Bead Mill manufactured by QIAGEN Company. The mixture is left to stand at room temperature for 3 hours, and then centrifuged at 15000 rpm and 4° C. for 10 minutes, and the thus-obtained supernatant is filtered with a 0.45 win membrane filter to obtain a measurement sample. The measurement of the amount of PRENCSO is performed by a known method (a method described in JP Patent Publication (Kokai) No. 2009-254344). The amount of remaining PRENCSO per fresh weight (FW) of the sample for analysis is calculated.

The amount of LF produced is the amount of a lacrimatory factor (LF, propanethial-S-oxide) in the crushed sample about 1 minute and 20 seconds after the raw onion is crushed. The lower the amount of LF produced, the lower the alliinase activity. The amount of LF can be measured using HPLC. The measurement of LF produced can be performed by a method described in International Publication WO 2014/178420, and the outline thereof is as follows.

400 mg of onion tissues collected by the same method as that for the sample for analysis of the amount of remaining PRENCSO are put in a 1.5 mL microtube. The sample is pulverized with a micro-pestle for 20 seconds, immediately followed by centrifugation at 15000 rpm and 4° C. for 10 seconds. The amount of a lacrimatory component (LF) in 1 μL of the centrifugal supernatant is analyzed by HPLC 1 minute and 20 seconds after the pulverization. HPLC analysis conditions are as follows. Under the HPLC analysis conditions, the lacrimatory component (LF) is detected in a retention time of about 9.6 minutes.

### [HPLC Analysis Conditions]

Column; ODS (SenshuPak ODS 4.6 mm×25 cm)
Mobile phase: Methanol: 0.005% aqueous trifluoroacetic acid=3:7
Detection: 254 nm
Column temperature 35° C.
Flow rate: 0.6 ml/min

Specific examples of the “onion in which expression of the alliinase gene is suppressed to less than 1/50 as compared to conventional breeds” are described in JP Patent No. 5671657, and scaly bulbs of plant bodies of onions grown from seeds internationally deposited as NCIMB 42219 or plant bodies of descendants thereof, and scaly bulbs of plant bodies of onions grown from calluses internationally deposited as BP-22260 or plant bodies of descendants thereof are particularly preferable.

Here, the term “descendant” of plant bodies of onions means plant bodies of onions which have been produced using plant bodies of onions or portions thereof with the utilization of sexual reproduction and/or asexual reproduction, wherein expression of the alliinase gene is suppressed to less than 1/50 as compared to conventional breeds.

The onion processed product of the present embodiment may further comprise additives. Examples of the additives include spices, colorants, flavors, sweeteners, buttering agents, sour agents, umami seasonings, fermented seasonings, protein hydrolysates, preservatives, anti-mold agents, antioxidants, emulsifiers, pH adjusters, lye water, thickening stabilizers, enzymes, agents for manufacturing, enrichments, and alum.

### <Method for Producing Onion Processed Product>

An embodiment of a method for producing an onion processed product as disclosed in the present description comprises:
a step of cutting an onion;
a step of heating the cut onion at 50° C. or more so that the cooking value is 900 or more and less than 10,000; and
a step of processing the heated onion to produce an onion processed product, wherein
the cooking value is obtained by integrating a value for an onion product temperature (A) [° C.], which is calculated by 10^{{(A-40)/10}}, with the time of heating [minute].

An onion processed product having the above-described characteristics can be produced by the method of the present embodiment. In the method of the present embodiment, a cut onion is heated, and therefore more uniform and rapid heating is possible as compared to the methods of Patent Literatures 1 and 2 in which a non-cut hall-shaped onion is heated.

The onion used as a raw material is not particularly limited, and is preferably an onion in which expression of the alliinase gene is suppressed to less than 1/50 as compared to conventional breeds. Preferred examples of the onion are as described above.

The step of cutting an onion refers to a step of cutting a raw onion into fragments. The step of cutting an onion is a step of cutting a raw onion into fragments in an arbitrary form such as a dice shape or a slice shape. It is particularly preferable to cut a raw onion into fragments having a dice shape about 5 mm to 20 mm on a side.

In the step of heating the cut onion, production of pyruvic acid by alliinase can be suppressed by setting the cooking value to 900 or more, so that an onion processed product is obtained which is less pungent and less bitter. On the other hand, the loss of hexanal by heating can be suppressed by setting the cooking value to less than 10,000, so that an onion processed product is obtained which has an original taste of onions and a fresh feeling. The cooking value is preferably 5,000 or less, more preferably 2,000 or less, particularly preferably 1,500 or less.

The cut onion product temperature in the heating step may be 50° C. or more, and is more preferably 55° C. or more, further preferably 60° C. or more, and preferably 80° C. or less, more preferably 75° C. or less, further preferably 70° C. or less. Here, the onion product temperature can be considered to be equal to the temperature of heating. For example, when the heating step is a step of heating the fragmented onion in water, the water temperature can be considered as the onion product temperature.

The method of heating in the heating step is not particularly limited, and may be a method in which the cut onion is added to water at a predetermined temperature to be heated, or a method in which the cut onion is exposed to air at a predetermined temperature to be heated.

The cooking value is a parameter indicating the amount of heating. When the temperature of heating is high and the time of heating is long, the cooking value is high. Specifically, the cooking value is obtained by integrating a value represented by the following equation (hereinafter referred to as a CV) with the time of heating (minute).

CV=10^{{(product temperature-standard temperature)/Z value}} (Equation):

The standard temperature and the Z value need to be fixed so as to compare amounts of heating in various heating conditions, while the values vary depending on the target. In the present description, the Z value is 10° C. and the standard temperature is 40° for heating the onion.

The CV is integrated with the time of heating (minute) to determine the cooking value. When the heating is performed at a constant temperature, the product temperature A (° C.) is a constant throughout the period of heating, and the product of the CV and the time of heating (minute) is the cooking value.

The step of processing the heated onion to produce an onion processed product may be an appropriate step corresponding to the onion processed product. Examples of the onion processed product include one or more selected from puree of onions, paste of onions, juice (squeezed juice, concentrated squeezed juice or diluted squeezed juice) of onions and crushed products of onions as described above. For example, when onion puree is produced, the heated onion is ground, and strained as necessary to produce onion puree. The step of processing the heated onion may comprise further blending additives as described above. In an embodiment in which the onion processed product is a packaged onion processed product, the step may comprise packing the onion processed product in the container.

In the following, the present invention will be described in detail with reference to Examples, but the scope of the present invention is not limited to these Examples.

### EXAMPLES

### <Raw Onion>

Onions whose typical seeds are internationally deposited as NCIMB 42219 were used as a raw onion.

### <Preparation of Puree>

The skin of a scaly bulb of the raw onion was stripped, and the raw onion was vertically cut, and then cut into a dice shape of 10 mm square.

150 g of the dice-shaped raw onion was put in a gauze cage, and heated in hot water at a predetermined temperature for a predetermined time. This heating step is called blanching. After the blanching, the onion sample was cooled together with the gauze cage for 1 minute using running water, and drained for 1 minute. After the draining, the onion sample was pulverized with a mill mixer to obtain an onion puree sample.

A value obtaining by integrating a value for a temperature during heating (A) [° C.] (considered as an onion product temperature), which is calculated by 10^{{(A-40)/10}}, with the time of heating [minute] was defined as a “cooking value”.

Sensory evaluation (pungency, bitterness and fresh feeling), measurement of the amount of pyruvic acid and measurement of the amount of hexanal for the onion puree sample were performed under the following conditions.

### <Sensory Evaluation>

30 minutes after the pulverization, the onion puree sample was eaten to evaluate pungency, bitterness and the fresh feeling.

The pungency was evaluated on the following three-point scale.
0: Pungency is not felt at all.
1: Pungency weaker than that of new onions is felt.
2: Pungency stronger than that of new onions is felt.

The bitterness was evaluated on the following three-point scale.
0: Bitterness is not felt at all.
1: Bitterness weaker than that of new onions is felt.
2: Bitterness stronger than that of new onions is felt.

The fresh feeling was evaluated on the following two-point scale.
0: Fresh feeling is not felt.
1: Fresh feeling is felt.

### <Measurement of the Amount of Pyruvic Acid>

The puree prepared by crushing the sample with the mill mixer was centrifuged at 15000 rpm and 4° C. for 10 minutes, and the supernatant was taken as a sample (extracted sample). 20 μL of the sample was put in a 96-well plate. 30 minutes after the pulverization, 43 μL of water and 66 μL of a solution of DNPH (2,4-dinitrophenylhydrazine) were added, and the mixture was reacted at 37° C. for 10 minutes. After 10 minutes, 66 μL of 1.5 M NaOH was added to stop the reaction, and pipetting was performed three or more times, followed by mixing. An absorbance at 515 nm was measured with a spectrophotometer. A calibration curve was prepared from values similarly determined using a dilution series of a solution of Na pyruvate instead of the extracted sample, and the measured absorbance value from the extracted sample was converted into the amount of pyruvic acid. From the thus-measured amount of pyruvic acid in the extracted sample of onion puree and the weight of the raw onion as a raw material which had been used for preparation of the onion puree, the amount of pyruvic acid per weight of onion puree calculated in terms of raw onion as a raw material (μmol/g) was calculated. The table below shows the results.

### <Measurement of the Amount of Hexanal>

The hexanal concentration in the onion puree was measured in accordance with the following procedure. From the measured hexanal concentration in the onion puree and the weight of the raw onion as a raw material which had been used for preparation of the onion puree, the hexanal concentration per weight of the onion puree calculated in terms of raw onion as a raw material (ppm (wt/wt)) was calculated. The table below shows the results.

### (Internal Standard Solution)

Internal standard reagent: Safrole CAS No. 94-59-7

Safrole is dissolved in methanol, and the solution is adjusted to about 100 ppm to obtain an internal standard solution.

### (Preparation of Standard-Added Sample)

As a test product to which a standard reagent is added (sample for standard addition), an onion puree sample heated under conditions which ensure that hexanal is not observed (conditions of a sufficiently high cooking value, for examples, heating conditions of 80° C. and 3 minutes (cooking value: 30000)) is used.

Standard reagent: Hexanal CAS NO. 66-25-1

Several levels of dilutions are prepared by dissolving hexanal in methanol, and diluting the solution with methanol to the extent that the amount of hexanal of the onion puree sample can be quantitatively determined. The dilutions are taken as standard solutions.

2.0 g of the sample for standard addition is sampled in a 20 mL vial with a micropipette.

50 μL of the standard solution is put in the 20 mL vial.

50 μL of the internal standard solution is put in the 20 mL vial.

0.5 g of sodium hydrochloride is added.

They are gently mixed by a micropipette.

The vial is capped tightly to give a standard-added sample, which is applied to an instrument.

An increase in weight of the onion puree sample from the standard solution is minor, and therefore is not taken into account.

### (Preparation of Measurement Sample)

2.0 g of the onion puree sample test product is sampled in a 20 mL vial with a micropipette.

50 μL of methanol is put in the 20 mL vial.

50 μL of the internal standard solution is put in the 20 mL vial.

0.5 g of sodium chloride is added.

They are gently mixed by a micropipette.

The vial is capped tightly to give a measurement sample, which is applied to an instrument.

### (Method of Measurement)

Instrument: Agilent GC-MS 5975C-MPS2
   [Conditions for Collection from Head Space]
SPME fiber: CARBOXEN/PDMS sky blue
Temperature of incubation: 37° C.
Time of incubation: 15 minutes
Rotation speed of agitator: 350 rpm
Time of collection: 10 minutes

### [Conditions for GC Measurement]

Injection port temperature: 250° C.
Method of injection: Splitless
Mode: Constant pressure
Injection port pressure: 7.0 psi
Liner: For SPME
Column: HP-5MS having a length of 30 m, an inner diameter of 0.25 mm and a thickness of 0.25 μm
Oven: 40° C. (held for 1 minute)→5° C./min→100° C.→40° C./min→300° C. (held for 5 minutes)

### [Conditions for MS Measurement]

Ionization mode: EI
Ionization energy: 70 eV
Measurement mode: Scan M/Z50-165
or SIM safrole M/Z162, 135, 131 hexanal M/Z100, 82, 72, 56
Ion source temperature: 230° C.
Quadrupole temperature: 150° C.

### (Method of Calculation)

For the standard-added sample, a calibration curve of area ratios between a hexanal peal and a safrole peak, which have been obtained by an ion chromatograph, at predefined M/Z, with respect to known hexanal concentrations in the standard-added sample is prepared.

For the measurement sample, an area ratio between a hexanal peak and safrole peak which are observed is applied to the calibration curve to calculate the hexanal concentration of the measurement sample.

### <Results>

TABLE 1

| Tem- | | Cook- | Pyruvic | | | | |
|---|---|---|---|---|---|---|---|
| perature | Time | ing | acid | Hexanal | Pun- | Bitter- | Fresh |
| (° C.) | (min) | value | (μmol/g) | (ppm) | gency | ness | feeling |
| 50 | 8 | 80 | 1.5 | 0.06 | 1 | 2 | 0 |
| 50 | 9 | 90 | 1.9 | 0.05 | 1 | 2 | 0 |
| 50 | 10 | 100 | 1.6 | 0.25 | 1 | 0 | 0 |
| 60 | 7 | 700 | 1.5 | 0.08 | 1 | 0 | 0 |
| 60 | 10 | 1000 | 1.4 | 0.07 | 0 | 0 | 1 |
| 65 | 1 | 316 | 2.1 | 0.12 | 1 | 1 | 1 |
| 65 | 3 | 949 | 1.1 | 0.12 | 0 | 0 | 1 |
| 70 | 1 | 1000 | 1 | 0.08 | 0 | 0 | 1 |
| 80 | 1 | 10000 | 0.5 | 0.02 | 0 | 0 | 0 |
| 80 | 2 | 20000 | 0.3 | 0.00 | 0 | 0 | 0 |
| 80 | 3 | 30000 | 0.3 | 0.00 | 0 | 0 | 0 |

All publications, patents and patent applications cited in the description are incorporated herein by reference.

Accession No. NCIMB 42219 was internationally deposited in NCIMB Ltd. (Ferguson Building, Craibstone Estate, Bucksbum, Aberdeen AB21 9YA, United Kingdom) by the applicant of the present application on Feb. 19, 2014. The address described in the accession certificate is that of the development laboratory of the applicant of the present application, and the depositor is identical to the applicant of the present application.

Accession No. FERM BP-22260 was internationally deposited in National Institute of Technology and Evaluation, Patent Organism Depositary (#120, 2-5-8, Kazusakamatari, Kisarazu-shi, Chiba, Japan, 292-0818 by the applicant of the present application on Dec. 25, 2013.

1. An onion processed product having a pyruvic acid content of less than 3.8 μmol/g and a hexanal content of 0.025 ppm (wt/wt) or more, with respect to the amount of the onion processed product calculated in terms of raw onion as a raw material.

2. The onion processed product according to claim 1, wherein the pyruvic acid content is less than 1.5 μmol/g with respect to the amount calculated in terms of raw onion as a raw material.

3. The onion processed product according to claim 1, which is a processed product of an onion in which expression of the alliinase gene is suppressed to less than 1/50 as compared to conventional breeds.

4. A method for producing an onion processed product, comprising:
a step of cutting an onion;
a step of heating the cut onion at 50° C. or more, so that the cooking value becomes 900 or more and less than 10,000; and
a step of processing the heated onion to produce an onion processed product, wherein
the cooking value is obtained by integrating a value for an onion product temperature (A) [° C.], which is calculated by 10^{{(A-40)/10}}, with the time of heating [minute].

5. The method according to claim 4, wherein the onion is an onion in which expression of the alliinase gene is suppressed to less than 1/50 as compared to conventional breeds.

6. The onion processed product according to claim 2, which is a processed product of an onion in which expression of the alliinase gene is suppressed to less than 1/50 as compared to conventional breeds.
